(19) United States
(12) Patent Application Publication
(10) Pub. No.: US 2025/0383707 A1
(43) Pub. Date: Dec. 18, 2025

(54) Method for Robust Automatic Adaptation of Head-up Displays

(71) Applicant: Bayerische Motoren Werke Aktiengesellschaft, Muenchen (DE)

(72) Inventors: Thomas EWENDER, Muenchen (DE); Andreas MENATH, Muenchen (DE)

(21) Appl. No.: 18/878,169

(22) PCT Filed: Jun. 7, 2023
(86) PCT No.: PCT/EP2023/065209

§ 371 Date: Dec. 23, 2024

(30) Foreign Application Priority Data
Jun. 24, 2022 (DE) 10 2022 115 866.7

(51) Int. Cl. G06F 3/01; B60R 16/037; G09G 3/00

(52) U.S. Cl. CPC G06F 3/013; B60R 16/037; G06F 3/012; G09G 3/001; G09G 2354/00; G09G 2380/10

(57) ABSTRACT

A method for robust adaptation of a device that is automatically trackable to a varying eye position of a user of the device for use in a vehicle, the method including ascertaining a current change in the eye position of the user, returning to ascertaining a change in the eye position if at least one of predetermined ignoring criteria that classifies the currently ascertained change as irrelevant is satisfied and none of predetermined exceptional circumstances that classify tracking as necessary is satisfied, and tracking the device according to the currently ascertained change in the eye position if none of the predetermined ignoring criteria is satisfied or if at least one of the predetermined exceptional circumstances is satisfied.

### BACKGROUND AND SUMMARY

The present disclosure relates to a method for robust adaptation of a device which is automatically trackable to a varying eye position of its user. The device and the method can be designed in particular for use in a motor vehicle or another land, air, or water vehicle, wherein the user is a driver of this vehicle, for example. The device can be designed in particular as a field-of-view display device for generating a virtual image inserted directly into the field of view of its user via reflection on a partially-transparent reflection pane, such as a windshield, rear window, or side window of the vehicle or a combiner pane provided separately for this purpose, which is arranged in the field of view of the user. The present disclosure is also directed to the device itself, a correspondingly configured control unit, and to a vehicle equipped therewith.

Using field-of-view display devices, which are also known under the name head-up display (HUD), in a motor vehicle, for example, speed specifications and other useful navigation and vehicle operation instructions or also entertainment content can be overlaid in the form of a virtual image on the real surroundings image in front of the vehicle observed by the driver or another occupant. For this purpose, an HUD in the classic design has a projection unit housed below an upper side of the instrument panel. This projection unit comprises, on the one hand, an imaging unit, such as a display, for generating a light beam bundle having the desired display content. Furthermore, the projection unit generally comprises a projection optical unit, which comprises one or more mirrors, for example, in order to reflect the light beam bundle in suitable shape and direction onto the abovementioned reflection pane, via reflection on which the display contents of the display are inserted into the field of view of the occupant. It is defined here by the selection of optical properties and mutual arrangement of individual components of the projection unit and the reflection pane at which distance, size, and quality of the virtual image is displayed behind the reflection pane and from which spatial area in the vehicle interior, which is intended for the eyes of the occupant and is often referred to as the “eyebox”, it is to be seen in each case.

It is always a requirement for the representation of static information, but very particularly for the display of contact-analog information (i.e. oriented on real objects behind the reflection pane) that ideally both, but at least one eye of the user is/are located within the eyebox. In known technical solutions, either manual settings for the relevant elements of the field-of-view display device are used for this purpose, or the eyebox location is automatically adapted via a camera-based recognition of the current eye position, i.e. any changes of the eye position of the user are tracked. For this purpose, in addition to a camera-based seating space occupancy detection, suitable solutions for detecting a head position in three spatial dimensions (3D) and/or the head orientation are also known from the prior art, for example, by estimation from the recordings of one or more 2D cameras. There are also corresponding solutions for the tracking of the current eye position for adapting the eyebox.

If the eye position is detected in a camera-based manner and used for tracking the eyebox without postprocessing and filtering, however, brief and rapid head movements as can often occur in the vehicle in the context of the driving activity for visual monitoring of the surroundings in and around the vehicle can also result in a corresponding rapid adjustment of the eyebox and thus wobbling and flickering of the display.

It is an object of the present disclosure to specify an alternative and/or improved operating method with regard to the user comfort, the display quality, and/or other aspects for a device automatically trackable to the eye position of its user, in particular a field-of-view display device, which is designed in particular for use in a vehicle.

This object is achieved by a method and by a corresponding control unit, device, and a vehicle equipped therewith according to the present disclosure. Further embodiments are specified in the present disclosure. All refining features and effects mentioned for the method in the claims and in the following description also apply with respect to the control unit, the device, and the vehicle, and vice versa.

According to a first aspect, a method for robust adaptation of a device which is automatically trackable to a varying eye position of its user is provided. The device and the method can be designed in particular for use in a vehicle. The vehicle can be a motor vehicle, but also any other land, air, or water vehicle.

The method presented herein comprises the following steps, which can be carried out during the operation of the device cyclically, for example at predetermined time intervals, which cannot be resolved by the human eye, and/or preferably in real time:

A current change of the eye position of the user is ascertained. It is then checked whether predetermined ignoring criteria, which classify the currently ascertained change of the eye position as irrelevant, are met. If this is the case, the method returns again to ascertaining the current change of the eye position of the user, unless at least one of predetermined exceptional circumstances, which nonetheless classify tracking as required, is met. If none of the predetermined ignoring criteria is met or if at least one of the predetermined exceptional circumstances is met, the device is automatically tracked in accordance with the currently ascertained change of the eye position of its user. Subsequently or parallel thereto, a current change of the eye position of the user is ascertained again and the entire method is repeated.

By suitable selection or specification of the ignoring criteria, on the one hand, and exceptional circumstances, on the other hand, in this manner a robust and continuous adaptation of the device to changing eye positions of its user can be achieved, using which undesired wobbling or flickering effects mentioned at the outset of the display or the position of the device upon jerky brief eye and head movements of the user can be reliably avoided.

Thus, for example, in the case of a field-of-view display device, such as a head-up display (HUD), an unnecessary and also undesired co-adaptation of the eyebox in the event of frequently occurring driver movements such as looking over the shoulder, looking into the side mirrors or inside mirrors, or a brief monitoring view of the instrument panel or on the rear bench seat can be precluded for the driver/controller of a vehicle. More rarely occurring or individual movements of the user can also be taken into consideration by a suitable generic definition of the ignoring criteria and the exceptional circumstances. Several examples of suitable specification of the ignoring criteria and the exceptional circumstances are specified below.

One concept of the method presented herein is thus, by specification of predetermined ignoring criteria and exceptional circumstances, to obtain a pre-sorted and thus robust 3D eye position of the user, which is then used for a continuous adaptation of the device, such as a projection position or eyebox of a head-up display, to any head and eye movements of the user.

For example, the check for meeting the predetermined ignoring criteria can comprise one, multiple, or ideally all of the following checks:
Ascertaining a current time derivative of the eye position of the user and checking whether this derivative exceeds a predetermined first threshold value. The device is only tracked to the currently ascertained eye position if the time derivative of the eye position is below this threshold, which is to be defined beforehand. Thus, for example, brief glances of a driver, for example toward a side mirror or inside mirror or toward an onboard instrument in the instrument panel, or rapid head movements, for example toward the front passenger or toward the rear bench seat or when looking over the shoulder, can be ignored by the automatic controller of the device. With this derivative of the eye position according to time, which can be ascertained, for example, from a camera-based monitoring of the face of the user or their pupils, among other things, excessively rapid head movements can also be recognized and ignored.
Alternatively or additionally, a current time derivative of a head position and/or head orientation (for example, a 6D head pose, thus three-dimensional position and three-dimensional orientation of the head) of the user can be ascertained and it can be checked whether this derivative exceeds a predetermined second threshold value. The device is only tracked to the currently ascertained eye position if the time derivative of the head position and/or head orientation is below this threshold, which is to be defined beforehand. Random rapid head movements of the user/driver can thus be ignored, for example, when looking toward the front passenger or toward the rear bench seat or when looking over the shoulder in a motor vehicle. Other sensors or optical cameras having a different detection area or evaluation algorithm can be used here, for example, than in the ascertainment of the time derivative of the eye position.
Ascertaining a viewing direction of the user and checking whether it has left a predetermined field of view area of the device. The viewing direction can be ascertained, for example, in a way known per se from camera-based monitoring of the pupils of the user. If, for example, a viewing direction outside a display area of the device, such as an HUD, or outside a predetermined or overall area of the windshield of the vehicle is established in this case, the associated change of the eye position of the user is thus not taken into consideration, i.e. the device or its eyebox is not tracked to this change. In this way, for example, not only rapid but also long or slow looks to the side or rear or over the shoulder of the user can be excluded from the (unnecessary) associated adaptation of the device, which is solely designed for their view in another direction, for example, forward or through the windshield or to the side and through a side window, etc.
Similarly to the check of the viewing direction, a head position and/or head orientation of the user can also be ascertained and subjected to a check as to whether it/they has/have departed from a predetermined head position and/or head orientation area of the device. In this way, for example, unusual poses of the user or their head which are unsuitable for use of the device can be excluded from the tracking, for example, bending over toward the glove compartment or inclining the head to observe something which is not related to the device.

In particular, in this case the ascertainment of a head position and/or head orientation of the user and the check as to whether it/they has/have departed from a predetermined head position and/or head orientation area of the device can be used as a replacement method if ascertaining a viewing direction of the user fails or is impossible. Ascertaining the viewing direction can be made more difficult or impossible, for example, in the case of events such as unfavorable lighting of the user face or reflection of the outside light on their spectacles or when wearing a baseball cap etc. if the eyes or in particular the pupils of the user are thus not or are not clearly recognizable.

The predetermined exceptional circumstances can comprise, for example, the detection of one or more of the following changes:
a change of a seat setting of an adjustable user seat, for example, the driver seat, which is naturally accompanied by an abrupt change of the eye position of the user;
a user change, such as a driver change, which is again accompanied by an abrupt change of the eye position of the user;
a predetermined state change of the device, which results in a corresponding change of the eye position or eyebox, such as a state change of the vehicle from residing to driving;
predetermined change(s) of a user assistance level or activation of user assistance functions of the device, which results/result in a corresponding change of the eye position or the eyebox. In the case of a vehicle, for example, these can be a change of the driver assistance level, activating driver assistance functions, turning on an autopilot, and much more.

In one specific embodiment, in the mentioned tracking step, the ascertained time-dependent change of the eye position is subjected to a low-pass filter before the corresponding adjustment of the device, which filter is designed to let change components having temporal frequencies below a predetermined filter frequency pass approximately unattenuated and to suppress change components having higher frequencies. For example, signal noise which is contained in the measurement signal of the eye position can be filtered out by such a low-pass filter and/or the signal can be smoothed. In this way, the ascertainment of the change of the eye position and the corresponding tracking of the device or the eyebox can be made even more robust and/or continuous, i.e. smoother.

In particular, the low-pass filter can be omitted in the predetermined exceptional circumstances mentioned herein. In other words, in these cases an immediate adaptation of the device is simply carried out according to the ascertained current change of the eye position. The abovementioned specificity of these exceptional circumstances is taken into consideration in this way.

According to one embodiment, the device mentioned herein is designed as a field-of-view display device, which is used to insert display contents into the field of view of the user via reflection on a partially transparent reflection pane arranged in their field of view, wherein an eyebox intended for the eyes of the user is trackable to their varying eye position. The field-of-view display device can be designed, for example, for inserting display content into the field of view of an occupant of the vehicle, in particular the driver, via reflection on a partially transparent reflection pane arranged in their field of view, for example, a windshield and/or a combiner pane provided separately for this purpose. The field-of-view display device can be, for example, a head-up display (HUD). The display of a respective display content by the field-of-view display device can be static or dynamic, and in particular also contact-analogous (i.e. oriented to real objects outside the vehicle), which in turn requires the knowledge of their current eye position and the adaptation upon its change.

Alternatively thereto, the device can also be designed, for example, as a head support of a user seat automatically adjustable depending on the current eye position and/or as an interior and/or exterior mirror of the vehicle automatically adjustable in a similar manner. In the latter case, the user is a driver of the vehicle.

Ascertaining a current change of the eye position of the user can be, for example, at least partially implemented by a camera system having one or multiple cameras. In particular at least one of these cameras can be installed in or on a movable interior mirror of the vehicle here, in such a way that it is movable together with the interior mirror. In this way, for example, a particularly accurate and flexible acquisition of the head and the eye part of the user can be implemented.

According to a further aspect, a control unit for actuating the device mentioned herein is provided, wherein the control unit is designed and configured for automatically carrying out the method presented herein. For this purpose, for example, a corresponding computer program can be installed in the control unit and can run during operation of the device.

According to a further aspect, a device, in particular for use in a vehicle, is provided which is trackable to a varying eye position of its user, for example, of a driver or another occupant of the vehicle. For this purpose, the device is equipped with the above control unit. The device can in particular also comprise at least one sensor and/or one eye tracking unit, which is/are designed and configured for acquiring a spatial area (eyebox) predetermined for the eyes of the user and for outputting a corresponding sensor and/or eye tracking signal for ascertaining a current change of the eye position of the user. The sensor or the eye tracking unit can comprise, for example, a camera system having one or more suitably positioned cameras, in particular infrared cameras for a reliable detection even in bad light conditions and at night. Suitable sensors and/or eye tracking units do not necessarily have to be provided as part of the device, however, rather they can also be added thereto later and/or also installed, for example, on board a vehicle in any case for driver and occupant monitoring.

The device can in particular be a field-of-view display device, such as a head-up display (HUD), having an automatically trackable eyebox. Alternatively or additionally, the device can also be designed as a head support of a user seat automatically adjustable depending on the current eye position of the user or as an automatically adjustable interior and/or exterior mirror of the vehicle. In the design as a field-of-view display device, the device can furthermore comprise an at least partially transparent reflection pane, which is arranged in the beam path of the light beam bundle generated thereby in operation and which is arranged in the field of view of the user and designed such that it reflects the light beam bundle to the eyebox predetermined for them, by which the display content is displayable to them in a virtual display area behind the reflection pane. The reflection pane can be designed, for example, as a section of a windshield of the vehicle or as a combiner pane arranged in front of it in the vehicle interior.

According to a further aspect, a vehicle, in particular a motor vehicle or any other land, air, or water vehicle is provided. The spatial orientation terms used herein such as “above”, “below”, “in front of”, “laterally”, “horizontally”, “vertically”, etc. always relate to the typical vehicle-fixed Cartesian coordinate system having longitudinal, transverse, and vertical axes of the vehicle perpendicular to one another.

The vehicle is equipped with the above device and can furthermore comprise, for example, a windshield and an instrument panel arranged underneath. If the device is a field-of-view display device, its imaging unit or possibly its entire projection unit (which can additionally comprise suitable projection optics in addition to the imaging unit) can in particular be arranged in the interior of the instrument panel or in/on its upper side, for example, installed directly on or below the upper side of the instrument panel in such a way that the light beam bundle from the projection unit or the imaging unit is thrown onto the windshield or a combiner pane positioned in the vehicle interior in front of it in the field of view of the driver or another occupant, which combiner pane is used as the abovementioned partially transparent reflection pane. Alternatively, the field-of-view display device can also be installed at any other suitable location in the vehicle, however.

The above aspects of the present disclosure and their specific design variants and embodiments are additionally explained in more detail hereinafter on the basis of examples illustrated in the appended drawings. The drawings are to be understood solely as schematic illustrations, i.e. as not to scale.

### BRIEF DESCRIPTION OF THE DRAWINGS

FIG. 1 shows an exemplary embodiment of a device of the type described herein, which is designed as a field-of-view display device in a vehicle, in a vertical longitudinal section; and

FIG. 2 shows a flow chart of an exemplary embodiment of a method of the type described herein for operating the field-of-view display device of FIG. 1.

### DETAILED DESCRIPTION OF THE DRAWINGS

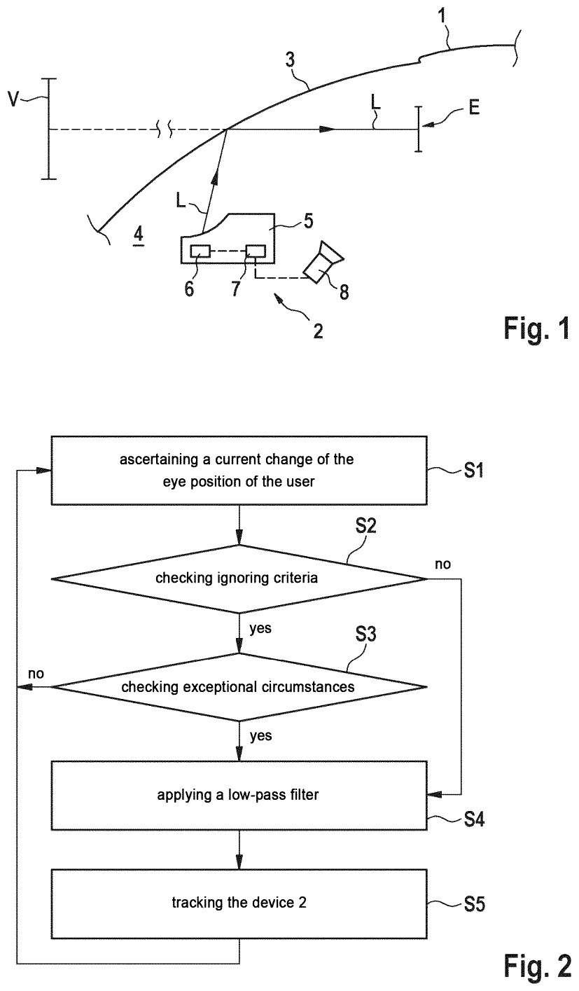

All different embodiments, variants, and specific design features of the method, the device, the control unit, and the vehicle, mentioned further above in the description and in the following claims, according to the above aspects of the present disclosure can be implemented in the examples shown in FIGS. 1 and 2. They are therefore not all repeated once again hereinafter. This also applies correspondingly to the concept definitions and effects already specified further above with respect to individual features which are shown in FIGS. 1-2.

FIG. 1 shows a very simplified schematic vertical longitudinal sectional representation of an exemplary embodiment of a vehicle 1 having a device 2 installed therein according to the aspects of the present disclosure described in more detail further above and in the claims. The device 2 is designed solely by way of example as a field-of-view display device for the driver of the vehicle 1, who is only indicated by their eyebox E.

The vehicle 1 is in this example a motor vehicle which is only indicated by its windshield 3. A projection unit 5 of the field-of-view display device is arranged underneath in an instrument panel 4 (not shown in more detail). The projection unit 5 contains an imaging unit 6 (also called picture generating unit, PGU) designed for generating a light beam bundle L having desired display contents, for example, a display, which is only symbolically indicated in FIG. 1. As mentioned further above, the projection unit 5 can comprise further optical elements (not shown separately in FIG. 1) such as mirrors etc. for forming and guiding the light beam bundle L in the beam path of the light beam bundle L, in order to track the eyebox E to a current eye position of the user (the driver here) and insert the display contents in desired projection depth, size, position, and quality in their field of view.

The light beam bundle L originating from the imaging unit 6 is indicated in simplified form by its center beam, which leads from a center of the display into a center of the eyebox E. The eyebox E is a spatial area in the vehicle 1 at a predetermined position in relation to the windshield 3, which is intended for the eyes of the driver, so that they can see an entire virtual display area V of the field-of-view display device. To adapt the eyebox E to various eye positions of the user, in this example the imaging unit 6 and/or the abovementioned optical elements of the projection unit 5 are actuated or adjusted suitably by a control unit 7 of the device 2.

Solely by way of example, the field-of-view display device is a head-up display (HUD). The windshield 3 is used in this example as a partially transparent reflection pane, so that the desired display contents are inserted in the form of virtual images into the field of view of the driver at some distance (also called projection depth) in front of the vehicle 1.

The control unit 7 is designed and configured to carry out a method according to the above first aspect of the present disclosure. It can be arranged, for example, in the projection unit 5 or outside it and can accordingly actuate the imaging unit 6 and possibly provided further projection optics during operation of the device 2.

Furthermore, at least one camera 8 is provided in the interior of the vehicle 1 which, as mentioned further above, is used as a sensor or component of an eye tracking unit for the purpose of ascertaining a current change of the eye position of the user and for this purpose is designed and configured to acquire a spatial area comprising their eyebox E and to output a corresponding sensor and/or eye tracking signal. One or more cameras 8 can, but do not have to be, considered to be part of the device 2. They can also be cameras installed in any case in the vehicle 1. In operation, the control unit 7 receives a sensor and/or eye tracking signal from the at least one camera 8.

FIG. 2 shows a flow chart of an exemplary embodiment of a method according to the above first aspect of the present disclosure for operating a device 2 of the type described herein, as is shown, for example, in FIG. 1. The method will be explained hereinafter on the basis of the example of FIG. 1. It comprises the following steps, which are carried out cyclically in real time during the operation of the device 2 in this example:

Step S1: During operation of the device 2, the at least one camera 8 in the interior of the vehicle 1 and/or the control unit 7 on the basis of the received camera signal ascertains a current change of the eye position of the user (the driver here). In addition, their 3D to 6D head pose (i.e. position and orientation) and/or their viewing direction can also be ascertained here.

Step S2: Subsequently, it is checked whether predetermined ignoring criteria which classify the currently ascertained change of the eye position as irrelevant are met. These can comprise, for example, ascertaining a current time derivative of the eye position of the user and checking whether this derivative exceeds a predetermined first threshold value; ascertaining a current time derivative of a head position and/or head orientation of the user and checking whether this derivative exceeds a predetermined second threshold value; ascertaining a viewing direction of the user and checking whether it has departed from a predetermined field of view area of the device (for example, the entire virtual display area V of the field-of-view display device or the entire area of the windshield 3); and ascertaining a head position and/or head orientation of the user and checking whether it/they has/have departed from a predetermined head position and/or head orientation area of the device 2. In particular, in this case ascertaining a head position and/or head orientation of the user and checking whether it/they has/have departed from a predetermined head position and/or head orientation area of the device can be used as a replacement method if ascertaining a viewing direction of the user has failed or is impossible.

If at least one of these checks has a positive result (“yes” in FIG. 2), it is checked in a further step S3 whether at least one of predetermined exceptional circumstances, which nonetheless classify tracking as required, is met. In this example, the predetermined exceptional circumstances comprise detecting one or more of the following changes: a change of a seat setting of an adjustable driver seat; a driver change; a predetermined state change of the vehicle, for example from residing to driving; and a predetermined change/predetermined changes of a driver assistance level or an activation of predetermined driver assistance functions, in particular a so-called autopilot, which change(s) the observation behavior of the driver.

If none of the predetermined ignoring criteria is met (“no” in FIG. 2 at step S2) or if at least one of the predetermined exceptional circumstances is met (“yes” in FIG. 2 at step S3), in a further step S4, the time-dependent change of the eye position ascertained in step S1 is subjected to a low-pass filter before the corresponding adjustment of the device 2, whereupon in a step S5, the eyebox E of the device 2 is automatically tracked in accordance with the (low-pass-filtered) currently ascertained change of the eye position of its user. In this case, the low-pass filter can also be omitted in the cases of the above predetermined exceptional circumstances, because a rapid change of the eyebox E is characteristic for these exceptional circumstances.

Otherwise (i.e. “yes” in FIG. 2 at step S2 and “no” in FIG. 2 at step S3), the method returns to step S1 again.

This method thus makes it possible to sort the changes of the eye positions of the user ascertained in real time systematically according to their relevance on the basis of predetermined ignoring criteria and exceptional circumstances and thus obtain a robust eye position of the user, which is subsequently used for a continuous adaptation of the eyebox E of the device 2. Undesired tracking of the eyebox E and wobbling or flickering of the image linked thereto can thus be reliably excluded in the event of random movements of the user such as looking over the shoulder, looking into the mirror, briefly looking back into the rear seat area of the vehicle, and much more.

### LIST OF REFERENCE SIGNS

1 vehicle
2 device, in particular field-of-view display device
3 windshield
4 instrument panel
5 projection unit
6 imaging unit
7 control unit
8 camera
I light beam bundle
V overall virtual display area that can be covered
E eyebox

1-10. (canceled)

11. A method for robust adaptation of a device, which is automatically trackable to a varying eye position of a user, for use in a vehicle, the method comprising:
ascertaining a current change of an eye position of the user;
returning to ascertaining the current change of the eye position in response to at least one of predetermined ignoring criteria being met and none of predetermined exceptional circumstances being met, wherein the predetermined ignoring criteria classify the currently ascertained change as irrelevant, and wherein the predetermined exceptional circumstances classify tracking as required; and
tracking the device in accordance with the currently ascertained change of the eye position in response to none of the predetermined ignoring criteria being met or at least one of the predetermined exceptional circumstances being met.

12. The method according to claim 11,
wherein determining whether the predetermined ignoring criteria is met comprises:
ascertaining a current time derivative of the eye position of the user, and checking whether the current time derivative of the eye position of the user exceeds a predetermined first threshold value; and/or
ascertaining a current time derivative of a head position and/or head orientation of the user, and checking whether the current time derivative of the head position and/or head orientation of the user exceeds a predetermined second threshold value; and/or
ascertaining a viewing direction of the user, and checking whether the viewing direction of the user has departed from a predetermined field of view area of the device; and/or
ascertaining a head position and/or head orientation of the user, and checking whether the head position and/or head orientation of the user has departed from a predetermined head position and/or head orientation area of the device.

13. The method according to claim 12,
wherein ascertaining the head position and/or head orientation of the user and checking whether the head position and/or head orientation of the user has departed from the predetermined head position and/or head orientation area of the device is used as a fallback method in response to ascertaining the viewing direction of the user failing or becoming impossible.

14. The method according to claim 11,
wherein the predetermined exceptional circumstances comprise detecting one or more of the following changes:
a change of a seat setting of an adjustable user seat;
a user change;
a predetermined status change of the device that results in a change of the eye position; and/or
one or more predetermined changes of a user assistance level or activation of user assistance functions of the device that results in a change of the eye position.

15. The method according to claim 11,
wherein tracking the device comprises:
subjecting the change of the eye position ascertained as a function of time to a low-pass filter before adjusting the device, wherein the low-pass filter is configured to let change components having frequencies below a predetermined limiting frequency pass approximately unattenuated and to suppress change components having higher frequencies;
omitting the low-pass filter in response to at least one of the predetermined exceptional circumstances being met; and
adjusting the device.

16. The method according to claim 11,
wherein the device is:
a field-of-view display device configured to insert display contents into a field of view of the user via reflection on a partially transparent reflection pane arranged in the field of view, wherein an eyebox intended for the eyes of the user is trackable to a varying eye position of the user;
an automatically adjustable headrest of a user seat; and/or
an automatically adjustable interior and/or exterior mirror of the vehicle, wherein the user is a driver of the vehicle.

17. The method according to claim 11,
wherein ascertaining the current change of the eye position of the user is at least partially implemented by a camera system having one or more cameras, and
wherein at least one of the one or more cameras is installed in or on a movable interior mirror of the vehicle in such a way that the one or more cameras is movable together with the interior mirror.

18. A controller comprising:
at least one computing device configured to:
ascertain a current change of an eye position of a user of a vehicle;
return to ascertaining the current change of the eye position in response to at least one of predetermined ignoring criteria being met and none of predetermined exceptional circumstances being met, wherein the predetermined ignoring criteria classify the currently ascertained change as irrelevant, and wherein the predetermined exceptional circumstances classify tracking as required; and
track the device in accordance with the currently ascertained change of the eye position in response to none of the predetermined ignoring criteria being met or at least one of the predetermined exceptional circumstances being met.

19. A device for use in a vehicle, the device configured to be tracked to a varying eye position of the user of the vehicle, the device comprising:
the controller according to claim 18; and
one or more cameras of a camera system, which is usable to ascertain the current change of the eye position of the user, and
wherein the device is designed as a field-of-view display device having an automatically trackable eyebox, or as an automatically adjustable headrest of a user seat, or as an automatically adjustable interior and/or exterior mirror of the vehicle.

20. The device according to claim 19,
wherein the one or more cameras is installed in or on a movable interior mirror of the vehicle in such a way that the one or more cameras is movable together with the interior mirror.

21. A motor vehicle comprising:
the device according to claim 19,
wherein the device is a field-of-view display device, wherein a reflection pane of the field-of-view device is a section of a windshield of the motor vehicle or as a combiner pane arranged in the vehicle interior in front of the windshield.

22. The controller according to claim 18, wherein the at least one computing device is configured to:
determine whether the predetermined ignoring criteria is met by:
ascertaining a current time derivative of the eye position of the user, and checking whether the current time derivative of the eye position of the user exceeds a predetermined first threshold value; and/or
ascertaining a current time derivative of a head position and/or head orientation of the user, and checking whether the current time derivative of the head position and/or head orientation of the user exceeds a predetermined second threshold value; and/or
ascertaining a viewing direction of the user, and checking whether the viewing direction of the user has departed from a predetermined field of view area of the device; and/or
ascertaining a head position and/or head orientation of the user, and checking whether the head position and/or head orientation of the user has departed from a predetermined head position and/or head orientation area of the device.

23. The controller according to claim 22, wherein the at least one computing device is configured to:
use the ascertaining the head position and/or head orientation of the user and checking whether the head position and/or head orientation of the user has departed from the predetermined head position and/or head orientation area of the device as a fallback method in response to ascertaining the viewing direction of the user failing or becoming impossible.

24. The controller according to claim 18,
wherein the predetermined exceptional circumstances comprise detecting one or more of the following changes:
a change of a seat setting of an adjustable user seat;
a user change;
a predetermined status change of the device that results in a change of the eye position; and/or
one or more predetermined changes of a user assistance level or activation of user assistance functions of the device that results in a change of the eye position.

25. The controller according to claim 18,
wherein the at least one computing device is configured to track the device by:
subjecting the change of the eye position ascertained as a function of time to a low-pass filter before adjusting the device, wherein the low-pass filter is configured to let change components having frequencies below a predetermined limiting frequency pass approximately unattenuated and to suppress change components having higher frequencies;
omitting the low-pass filter in response to at least one of the predetermined exceptional circumstances being met; and
adjusting the device.
